(19) United States
(12) Patent Application Publication
(10) Pub. No.: US 2020/0065677 A1
(43) Pub. Date: Feb. 27, 2020

(54) MACHINE LEARNING ASSISTED EVENTS RECOGNITION ON TIME SERIES COMPLETION DATA

(71) Applicant: Well Data Labs, Inc., Denver, CO (US)

(72) Inventors: Jessica G. Iriarte Lopez, Denver, CO (US); Alberto J. Ramirez Ramirez, Denver, CO (US); Joshua M. Churlik, Broomfield, CO (US)

(73) Assignee: Well Data Labs, Inc., Denver, CO (US)

(21) Appl. No.: 16/550,026

(22) Filed: Aug. 23, 2019

Related U.S. Application Data
(60) Provisional application No. 62/722,612, filed on Aug. 24, 2018.
(60) Provisional application No. 62/776,294, filed on Dec. 6, 2018.

(51) Int. Cl. G06N 3/08; G06N 3/04

(52) U.S. Cl. CPC G06N 3/084; G06N 3/04

(57) ABSTRACT

Hydraulic fracturing data can be processed by a trained machine learning model to identify hydraulic fracturing well data characteristics corresponding with hydraulic fracturing events. The model can be trained using pre-processed hydraulic fracturing well data including multiple data channels. The trained model can then be fed hydraulic fracturing well data to identify stage start times, stage end times, and instantaneous shut-in pressure values among other well data events.

### CROSS-REFERENCE TO RELATED APPLICATION

This application is related to and claims priority under 35 U.S.C. § 119(e) from U.S. Patent Application No. 62/722,612, filed Aug. 24, 2018, entitled “MACHINE LEARNING ASSISTED EVENTS RECOGNITION ON TIME SERIES FRAC DATA,” and from U.S. Patent Application No. 62/776,294, filed Dec. 6, 2018, entitled “MACHINE LEARNING ASSISTED EVENTS RECOGNITION ON TIME SERIES COMPLETION DATA,” both of which are hereby incorporated by reference in their entirety.

### TECHNICAL FIELD

Aspects of the present disclosure involve machine learning analysis of time sequenced fracture data to uniformly and automatically identify events, such as a start time and end time, of a treatment sequence within the data.

### BACKGROUND

Hydraulic fracturing data is typically recorded and mapped in the field at one-second intervals. In general terms, fracturing a well (e.g., hydraulic fracturing, etc.) involves pumping fluid under high pressure into a wellbore, which is typically cased, perforated and separated into distinct stages that are hydraulically fractured. The fluid, typically mostly water, flows through the perforations and into the formation surrounding the well bore to release oil and gas to flow into the well bore and to the surface. The designation of the start and end time of pumping is very important because these boundaries may govern summary hydraulic fracturing statistics and calculations, such as pressures, pumping rates, and proppant concentrations. Similarly, the identification of other operations and events within a hydraulic fracturing data set can be equally important. Conventionally, events with a hydraulic fracturing data set are manually identified and labeled, which is often very time consuming, sometimes inaccurate, and often inconsistent due to a lack of a uniform selection method or interpretation across individuals and organizations.

It is with these observations in mind, among others, that aspects of the present disclosure were conceived.

### SUMMARY

A method for identifying characteristics of well data includes pre-processing well data, the well data including one or more data channels corresponding to one or more sensor values from a well, smoothing the pre-processed well data with a first smoothing window, and feeding the smoothed well data to the trained model, the trained model identifying characteristics of the received well data, wherein the trained model has been trained by pre-processing a training data set of well fracturing data, selecting multiple stages for training a model, each stage correlating to an interval in which well fracturing operations are performed, the model corresponding to the trained model, labeling the pre-processed data based on the selected multiple stages, smoothing the pre-processed training data with a second smoothing window, the second smoothing window of a particular size different than a size of the first smoothing window, and training the model using the smoothed training data, the model trained to identify well data characteristics in data.

In an embodiment of the method, the model includes one or more of a logistic regression model or a neural network binary classifier.

In an embodiment of the method, the characteristics include one of stage start times or stage end times, each identified by the trained model identifying a sequential portion of the received well data as from a hydraulic fracturing stage, the stage start time corresponding to a beginning time of the sequential portion and the stage end time corresponding to an ending time of the sequential portion.

In an embodiment of the method, selected features of the training data are smoothed, and the trained model has been further trained by selecting features from the training data, the selected features used by the trained model to identify the well data characteristics.

In an embodiment of the method, feeding the smoothed well data to the trained model includes fitting a linear regression model to the pre-processed well data to generate instantaneous shut-in pressure (ISIP) flags, the ISIP flags corresponding to a pressure value correlated to a slurry rate value equal to zero.

In an embodiment of the method, pre-processing the well data includes identifying one or more intervals of the well data from which ISIP values may be generated, wherein a binary neural network classifier identifies the one or more intervals, and labeling the well data according to the identified one or more intervals.

In an embodiment of the method, the method further includes generating a heat map interface based on the ISIP flags, the heat map interface including ISIP flags indicators for multiple stages of multiple wells.

In an embodiment of the method, the heat map interface further includes visual groupings of stage heat maps, the groupings corresponding to formations to which respective stage data is related.

A system for identifying characteristics of well data includes one or more processors, and a memory including instructions to pre-process well data, the well data including one or more data channels corresponding to one or more sensor values from a well, smooth the pre-processed well data with a first smoothing window, and feed the smoothed well data to the trained model, the trained model identifying characteristics of the received well data, wherein the trained model has been trained by pre-processing a training data set of well fracturing data, selecting multiple stages for training a model, each stage correlating to an interval in which well fracturing operations are performed, the model corresponding to the trained model, labeling the pre-processed data based on the selected multiple stages, smoothing the pre-processed training data with a second smoothing window, the second smoothing window of a particular size different than a size of the first smoothing window, and training the model using the smoothed training data, the model trained to identify well data characteristics in data.

In an embodiment of the system, the model includes one or more of a logistic regression model or a neural network binary classifier.

In an embodiment of the system, the characteristics include one of stage start times or stage end times, each identified by the trained model identifying a sequential portion of the received well data as from a hydraulic fracturing stage, the stage start time corresponding to a beginning time of the sequential portion and the stage end time corresponding to an ending time of the sequential portion.

In an embodiment of the system, selected features of the training data are smoothed, and the trained model has been further trained by selecting features from the training data, the selected features used by the trained model to identify the well data characteristics.

In an embodiment of the system, feeding the smoothed well data to the trained model includes fitting a linear regression model to the pre-processed well data to generate instantaneous shut-in pressure (ISIP) flags, the ISIP flags corresponding to a pressure value correlated to a slurry rate value equal to zero.

In an embodiment of the system, pre-processing the well data includes identifying one or more intervals of the well data from which ISIP values may be generated, wherein a binary neural network classifier identifies the one or more intervals, and labeling the well data according to the identified one or more intervals.

In an embodiment of the system, the memory further includes instructions to generate a heat map interface based on the ISIP flags, the heat map interface including ISIP flags indicators for multiple stages of multiple wells.

In an embodiment of the system, the heat map interface further includes visual groupings of stage heat maps, the groupings corresponding to formations to which respective stage data is related.

A non-transitory computer readable medium stores instructions that, when executed by one or more processors, cause the one or more processors to pre-process well data, the well data including one or more data channels corresponding to one or more sensor values from a well, smooth the pre-processed well data with a first smoothing window, and feed the smoothed well data to the trained model, the trained model identifying characteristics of the received well data, wherein the trained model includes one or more of a logistic regression model or a neural network binary classifier, and the trained model has been trained by pre-processing a training data set of well fracturing data, selecting multiple stages for training a model, each stage correlating to an interval in which well fracturing operations are performed, the model corresponding to the trained model, labeling the pre-processed data based on the selected multiple stages, smoothing the pre-processed training data with a second smoothing window, the second smoothing window of a particular size different than a size of the first smoothing window, and training the model using the smoothed training data, the model trained to identify well data characteristics in data.

In one embodiment of the non-transitory computer readable medium, the characteristics include one of stage start times or stage end times, each identified by the trained model identifying a sequential portion of the received well data as from a stage, the stage start time corresponding to a beginning time of the sequential portion and the stage end time corresponding to an ending time of the sequential portion.

In one embodiment of the non-transitory computer readable medium, feeding the smoothed well data to the trained model includes fitting a trained linear regression model to the pre-processed well data to generate instantaneous shut-in pressure (ISIP) flags, the ISIP flags corresponding to a pressure value correlated to a slurry rate value equal to zero, and wherein pre-processing the well data further includes identifying one or more intervals of the well data from which ISIP values may be generated, wherein a binary neural network classifier identifies the one or more intervals, and labeling the well data according to the identified one or more intervals.

In one embodiment of the non-transitory computer readable medium, the instructions further cause the one or more processors to generate a heat map interface based on the ISIP flags, the heat map interface including ISIP flags indicators for multiple stages of multiple wells and visual groupings of stage heat maps, the groupings corresponding to formations to which respective stage data is related.

### BRIEF DESCRIPTION OF THE DRAWINGS

FIG. 1 is an example plot of a hydraulic fracture treatment, in accordance with the subject technology;

FIG. 2 is flowchart of an example method for flagging start and end times of a hydraulic fracturing treatment, in accordance with the subject technology;

FIG. 3 is an example plot of noisy hydraulic fracturing data, in accordance with the subject technology;

FIG. 4 is an example plot of Boolean flagged data, in accordance with the subject technology;

FIG. 5 is an example plot of an overt it trained model, in accordance with the subject technology;

FIG. 6 is an example plot of hydraulic fracturing data flagged with start and end times, in accordance with the subject technology;

FIG. 7 is an example plot of hydraulic fracturing data channels used to predict instantaneous shut-in pressures, in accordance with the subject technology;

FIG. 8 is an example plot of hydraulic fracturing stage data flagged with predicted instantaneous shut-in pressures, in accordance with the subject technology;

FIG. 9 is a block diagram of an example system for predicting events based on well data, in accordance with the subject technology;

FIG. 10 is an example plot of training data, in accordance with the subject technology;

FIG. 11 is an example plot of labeled data collected from multiple stages, in accordance with the subject technology;

FIG. 12 is an example plot of hydraulic fracturing data classified by a neural network, in accordance with the subject technology;

FIG. 13 is an example plot of smoothed labeled hydraulic fracturing data, in accordance with the subject technology;

FIGS. 14A-B are example plots of processed hydraulic fracturing data with outlier data left in and removed, respectively, in accordance with the subject technology;

FIG. 15A-C are example plots of linear regressions for processed hydraulic fracturing data, in according with the subject technology;

FIG. 16 is an example graphical user interface, in accordance with the subject technology; and

FIG. 17 is an example computing system embodiment, in accordance with the subject technology.

### DETAILED DESCRIPTION

Aspects of the present disclosure involve a method and system for automating the identification of various attributes of a fracturing data set, such as automatically labeling stage start and end time flags, of a fracturing data set by way of a machine learning algorithm learning to consistently and accurately label the fracturing stage data. The machine learning algorithm may be trained over a large amount of labeled data and without explicit programming rules or relationships between start and end time flags and characteristics of processed data. Additionally, techniques discussed herein may be further applicable to automatically identify other events within fracturing data and generate labels respective to the same. Accurately labeled data sets can provide for the ability to accurately compare fracturing data across wells, within a formation or otherwise, and/or obtain information useful information, either derivatively or directly, for designing new fracturing plans, among other advantages.

The techniques discussed herein include processing metered high-frequency treatment data with a supervised machine learning algorithm. In one specific example, hydraulic fracturing data (e.g., pumping data, etc.) may include variables for treating pressure, slurry rate, clean volume, and proppant concentration for 179 stages, making up for a total of 1,530,445 rows of data per variable. In some examples, sixty-six percent (66%) of the data may be used to train a machine learning model, eight percent (8%) of the data may be used to validate the machine learning model, and the remaining twenty-five to twenty-six percent (25%-26%) of the data may be used to test the machine learning model. User defined start and end time flags for stages can be used to teach and train the machine learning model. In general, a “stage” refers to a discrete length of a respective well-bore. It is often useful to accurately determine the time at which hydraulic fracturing operations (e.g., drilling, treatment, etc.) have entered into a new stage and/or exited a previous stage. While specific examples of variables, numbers of stages, and percentages are disclosed for the example process, the techniques discussed herein are not limited to the specific example referenced and variations on variables, stages, number of stages, percentages, etc. may be utilized without departing from the spirit and scope of this disclosure.

In general, pumping data behaves differently from other traditional time-series datasets. For example, examined variables may not be affected by time but rather by physical events. As a result, correlations and/or dependencies between variables can affect accurate pattern recognition. To facilitate accurate event identification, a dataset may be pre-processed so training the machine learning model can utilize leaner loss functions, efficient smoothing techniques, and/or an improved rate of change in the main data channels of the pre-processed dataset. Two classifiers (e.g., machine learning models), a logistic regression and/or a support vector machine, can be used to determine how characteristics of the data or dataset may impair predictions and also to evaluate performance of trained machine learning models.

Using the classifier, an accurate prediction can be generated of where pumping of a hydraulic fracturing stage starts and ends in a high-frequency treating plot. In some examples, start and end time prediction logistic regression models can have a training and validation accuracy of approximately ninety percent (90%). In some examples, the model may benefit from retraining periodically with new field data to improve the prediction robustness and maintain high accuracy. An accurate start and end time selection can make it viable to process large volumes of hydraulic fracturing treatment data and also reduce time required to review field data (e.g., by quality control petroleum engineers, etc.). For example, without imputing limitation and solely for purposes of explanation and clarity, multi-stage hydraulic fracturing operations may be performed in an oil and gas well to maximize reservoir contact and enhance oil and gas production. Hydraulic fracturing involves the injection of fluids and proppants into the well at high pressures in order to overcome the breakdown and propagation pressure and keep the fractures open.

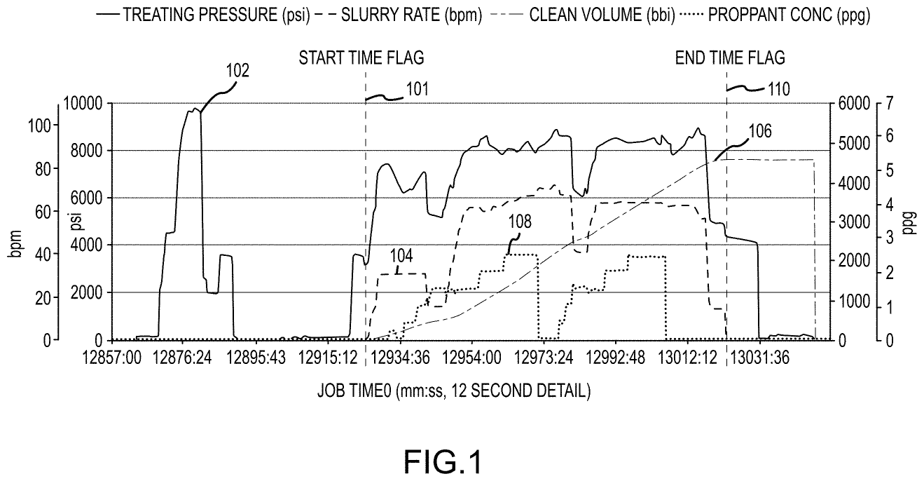

During these operations, data channels for measurements of pressures, pump rates, pumped fluid volumes, and proppant concentrations, among other possible fields, may be recorded at, for example and without imputing limitation, one-second intervals. FIG. 1 is a plot 100 of an example hydraulic fracture treatment for a stage. Plot 100 includes data channels 102-108 as well as a start time flag 101 and an end time flag 110.

Start time flag 101 and end time flag 110 may, for example, be used to govern summary fracture statistics calculations for a respective stage among other things. In effect, start time flag 101 and end time flag 110 may limit data included when determining average and/or maximum pressures, rates, and/or concentrations, as well as cumulative volumes and pumping time. In some examples, plot 100 can be generated from raw pumping data gathered from equipment in the field and stored in comma-separated value (.csv) files at one-second intervals. The .csv files may be stored and/or collected in a cloud-based software that standardizes naming conventions and/or units in all the files. In some examples, the stored .csv files may be visualized (e.g., by the cloud-based software into a graphical user interface) as one or more treating plots for eased stage selection. The treating plots may include color coded data channels associated with various sensor values over multiple stages as well as trend lines associated with each data channel. As a result, stages may be identified based on particular patterns across the data channels such as, for example, a combination or ratio of slurry rate (SR) values and treatment pressure (TP) values within a certain window, etc.

Discrete events in, or associated with, a fracturing job can be identified by a machine learning model trained on data labeled with common interpretations. As a result, the model need not be explicitly programmed to identify particular events. In particular, the data may be split into categories, such as true or false, and three datasets for training, validation, and testing, respectively, can be produced from the categorized data. The training dataset is composed of features for teaching the selected machine learning model a binary classification corresponding to the true and false categories. The machine learning model may then process the training dataset to recognize patterns and trends that can be used to accurately classify data points (events) (e.g., in other datasets such as the validation and testing datasets or new datasets produced from wells). The validation dataset has the same format of the training dataset but, in at least one example, may include data for fewer stages. Once the machine learning model is trained, the validation dataset can be used to generate a prediction column including values indicating whether the machine learning model predicts a row (e.g., data point) is a member of a particular category (e.g., true or false) and the data of which may then be compared to respective category data of the same row.

The system applies a confusion matrix to the validation dataset and corresponding values of the prediction column to determine accuracy, precision, and recall of the trained machine learning model. For example, a high accuracy, precision, and/or recall percentage value may be used to determine the generalizability and/or quality of the trained model. The test dataset has different stages from the training and validation datasets. For example, the testing dataset can have the same features (e.g., data channels, relationships between data channels, etc.) as the training and validation datasets, but may not be categorized (e.g., flagged with true and false or zeroes and ones, etc.). The system can use the testing dataset with the trained and validated machine learning algorithm to predict whether portions of the testing dataset are, for example, within the stage for which the model is being trained.

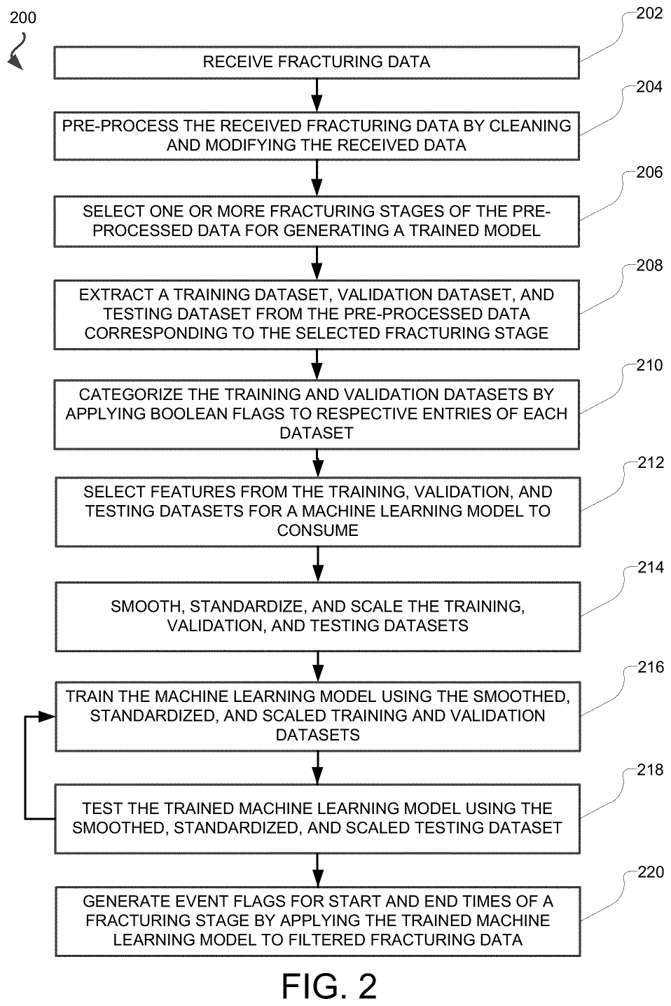

A discussion of particular examples of aspects of training a machine learning model to identify particular events (e.g., stage and associated start and/or stop times, instantaneous shut-in pressure events and associated values, etc.) in a hydraulic fracturing dataset and flag said events with reference to FIGS. 2-17 follows. While the discussion refers to respective start and end times of, for example and without imputing limitation, treatment fluid entering into, and completing treatment of, a selected stage (referred to herein as “stage start” and “stage end” times, respectively) and instantaneous shut-in pressure (ISIP) events, such examples are for explanatory purposes only and are not to be taken as unduly limiting the scope or content or the disclosure herein. For purposes of this disclosure, where data, operations, events, etc. are described as occurring “in” or “from” a stage, it is understood that said data, operations, events, etc. reflect a hydraulic fracturing processes occurring to said stage. It is understood that other events may be detected based on the system and methods discussed herein and/or variations on the systems and methods disclosed herein may be employed without departing from the spirit and scope of the disclosure.

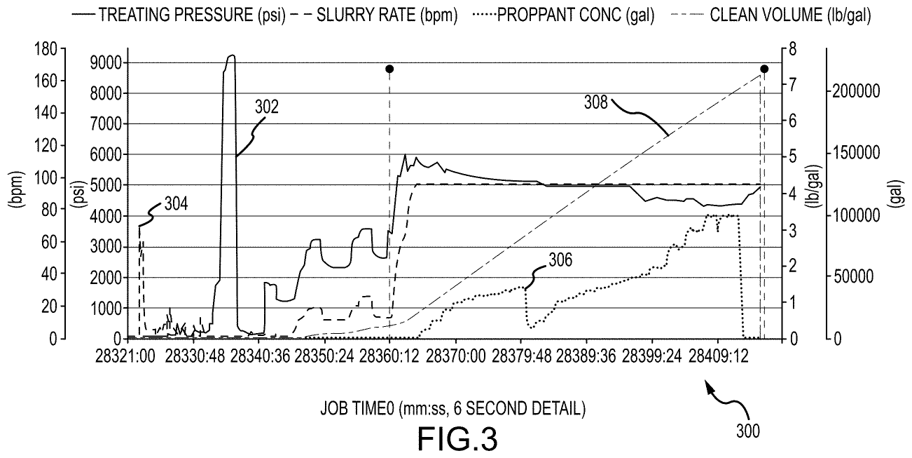

FIG. 2 depicts a method 200 for generating event flags for fracturing data using a trained machine learning model. FIGS. 3-8 depict various graph-based visualizations corresponding to the operations of method 200. While certain graph-based visualizations are disclosed, it is understood that the particular visualizations and data used are for non-limiting explanatory purposes only and that various and different graphical interface elements may be used to communicate aspects of the operations of method 200 to a user without departing from the spirit or scope of the disclosure.

At operation 202, the system accesses fracturing data. In some examples, the fracturing data may be log data, for example, stored on and retrieved from a data store. In some examples, the fracturing data may be received from a live well such as a test well, laboratory well, producing well, or the like. In general, the fracturing data includes multiple channels such as, for example and without imputing limitation, treating pressure, slurry rate, proppant concentration, and clean medium volume.

In addition, for purposes of training the machine learning model, the fracturing data may be from selected stages where the respective data is very clean and start and end times are very clear (e.g., to a human observer), such as in the case of FIG. 1 discussed above, as well as selected stages where the respective data is noisy, such as in the case of FIG. 3. Typically, noisy data displays arbitrary, albeit small and sudden, peaks and troughs associated with, for example, tool error, external forces such as surface level vehicle traffic, and the like. FIG. 3 depicts plot 300 of relatively noisy fracturing data and includes data for treating pressure (TP) 302, slurry rate (SR) 304, proppant concentration (PC) 306, and clean volume (CV) 308. In many cases, TP, SR, CV, and PC may be selected as the initial features for training (discussed below in reference to operation 212).

Returning to FIG. 2, at operation 204, the fracturing data is pre-processed. Pre-processing includes cleaning the data, which may entail removing outlier values and the like, and other modifications to the data to increase the efficiency of training (e.g., renaming variables, generating derivative variables, applying transforms, etc.). Removing outliers, for example, involves determining a threshold value, such as a maximum deviation from a mean or the like, and removing data that is exceeds that threshold (e.g., removing data that is more than a standard deviation from a determined mean, etc.). As a result, the respective data is more consistent and processes used with it, such as training a machine learning model or the like, are less likely to be influenced (e.g., biased) by outlying data, which may otherwise cause a resultant trained model to be poorly fit to a theoretical global mean.

At operation 206, one or more fracturing stages are selected from the pre-processed data which may be used to generate a trained model for predicting whether and which stage fracturing data belongs to and, as a result, identifying stage start and stage end times. As discussed above, stages may be selected for a variety of reasons such as the data for the stage is less noisy than data for other stages, to specialize the trained model for a particular stage or stages, to reduce training time for the machine learning model, etc.

At operation 208, a training dataset, a validation dataset, and a testing dataset corresponding to the selected stages are extracted from the pre-processed data. As discussed above, in one example, 66% of the extracted data may be used for the training dataset, 8% may be used for the validation dataset, and 26% may be used for the testing dataset. While other distributions of extracted data to training dataset, validation dataset, and testing dataset (e.g., hyper-parameters) may be used, the ratio above was selected based on empirical determination of its efficacy in training certain machine learning models.

At operation 210, the stages having been selected and respective datasets extracted, the training and validation datasets are categorized by applying Boolean flags to respective entries of each dataset. For example, a zeros (0) or one (1) may be tagged to each row of data for a stage of the training dataset by adding a StartOrEnd column to the end of each row (e.g., concatenating a Boolean field to the dataset). Ones represent that data of a particular row belongs to the particular stage or stages being trained for and zeros represent that data of the particular row does not belong to the stage time. As a result, portions of the data, in many cases large sequential stretches of rows, are tagged as being from a particular stage of a respective hydraulic fracturing process.

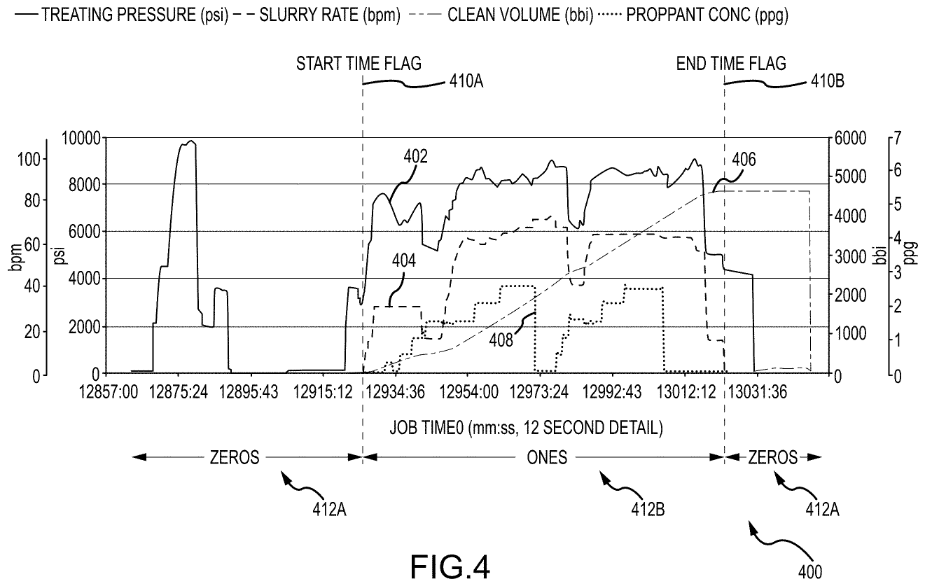

FIG. 4 depicts a plot 400 corresponding to the categorized data of operation 210 above. In particular, plot 400 includes lines for TP 402, SR 404, CV 406, and PC 408 (e.g., corresponding to TP 102, SR 104, CV 106, and PC 108 respectively). A start time flag 410A and an end time flag 410B bound a ones portion 412B of the data which is categorized as “true” or belonging to the stage time being trained for. Likewise, zeros portions 412A correspond to data outside the bounded zone. In some examples, a subject matter expert (SME) may define start time flag 410A and end time flag 410B by reviewing the selection of data corresponding to the one or more fracturing stages being trained for. In some examples, the SME may define multiple start time flags and/or end time flags either for different stages or for the same stage where the SME is uncertain as to the correct start and/or end times based on the data. While stage start and/or end times are discussed, it is understood that other hydraulic fracturing events (e.g., ISIP, etc.) may be likewise flagged by the SME.

In some examples .csv files for the selected data is then concatenated into a single training dataset. The validation dataset may be concatenated and tagged using the same process. At operation 212, features are selected from the training, validation, and testing datasets for a machine learning model to consume through at least a portion of the training process. As discussed above, in at least some examples, TP, SR, CV, and PC may be initially selected. In some examples, additional and/or alternative features may be selected throughout the training process.

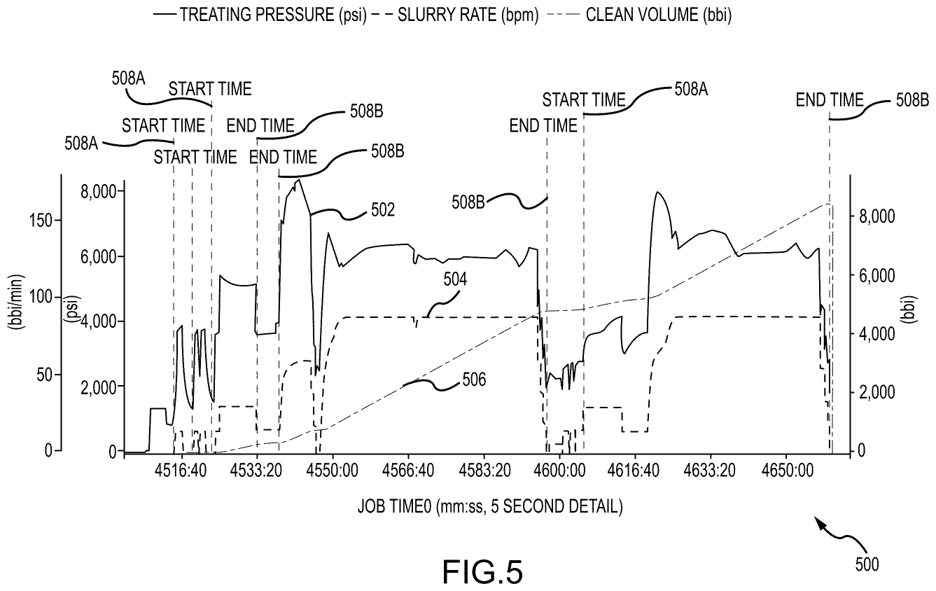

At operation 214, the training, validation, and testing datasets features are smoothed and standardized by removing the mean and scaling to unit variance. In effect, smoothing and standardizing the datasets can avoid overfitting the trained machine learning model to the data. When the model is overfit, it may flag arbitrary combinations of features as start and/or end times. FIG. 5 depicts one such example in plot 500, which includes lines for TP 502, SR 504, and CV 506. In particular, the respective model sets start time flags 508A wherever TP 502 and SR 504 exhibit substantially simultaneous and substantially instantaneous changes in value and, likewise, sets end time flags 508B where TP 502 and SR 504 exhibit substantially simultaneous and substantially instantaneous changes in value following at least one start time flag 508A. In effect, the machine learning model has been overfit to its training data.

At operation 216, the machine learning model is trained using the smoothed, standardized, and scaled training and validation datasets. In one example, the model is trained using backpropagation techniques fitting an initialized curve to the selected features and the training and validation datasets labeled by SMEs. Other training methodologies may be utilized for generating a trained machine learning model such as various selections of epoch size, batch size, error functions, propagation techniques (e.g., equilibrium propagation, etc.), and the like without departing from the spirit and scope of this disclosure.

At operation 218, the trained machine learning model is tested using the smoothed, standardized, and scaled testing dataset. In some examples, the testing dataset may be labeled similarly to the training and validation datasets (e.g., categorized according to a Boolean value). As a result, output classifications from the trained machine learning model can be compared to respective testing dataset labels to determine accuracy of the trained machine learning model. In some examples, the trained machine learning model may be evaluated through a downstream program (e.g., a model testing toolkit, etc.) or by one or more SMEs. Nevertheless, where a predetermined threshold accuracy (e.g., 90% accuracy, etc.) is achieved or exceeded, method 200 proceeds to operation 220. Where the trained machine learning model does not perform at or above the threshold accuracy, method 200 may loop back to operation 216 in order to continue training the machine learning model.

At operation 220, the trained machine learning model having achieved or exceeded the predetermined threshold accuracy, event flags (e.g., stage start time flags, stage end time flags, etc.) are generated by applying the trained machine learning model to filtered fracturing data. The filtered fracturing data may be received from a data store or well environment. In general, the filters may approximate pre-processing to make characteristics of the filtered fracturing data substantially similar to those of the pre-processed fracturing data from operation 204 and onwards.

### Model Selection & Trials

It was recognized that pumping data behaves very differently from most traditional time-series datasets; thus, conventional techniques were not available. In some aspects, the selected features are not affected by time but by physical events and so correlation and/or dependency between variables (e.g., features) can affect accurate pattern recognition. In some examples, the machine learning model may be a logistic regression classifier. In some other examples, a support vector machine with a ‘rbf’ kernel may be used for the machine learning model. Additionally, multiple models may be used in, for example, an iterative processing approach and/or an ensemble architecture.

Selection of one or the other (or any particular) machine learning model may be made based on trial training runs. Table 1 below summarizes one example of a set of trials run for a logistic regression model and a support vector machine model. In particular, when a test dataset is run through the trained and validated logistic regression classifier, a column with a predicted StartOrEnd Boolean value (e.g., “1” or “0”) can be concatenated to the respective dataset for review and evaluation. The difference between the rows is calculated to find where the changes between Boolean value series occur (e.g., where a change from 0s to 1s and/or 1s to 0s occurs). A start and end time list can then be generated containing an index of these changes as well as a associated job time, well name, and/or stage number. Additionally, certain filters can be applied to the dataset to select the appropriate predictions for each stage.

TABLE 1
Comparison of model trials between a logistic regression model
and a support vector machine model.

| | Training | Validation | Test | | | |
|---|---|---|---|---|---|---|
| | (Wells/ | (Wells/ | (Wells/ | | | |
| Trial | Stages) | Stages) | Stages) | SMA | Model | Features |
| T1 | 6/60 | 4/14 | 14/50 | No | Log Reg/ | TP, SR |
| | | | | | k-SVM | TP, CV |
| | | | | | | SR, CV |
| | | | | | | SR, CV, PC |
| | | | | | | TP, SR, CV |
| T2 | 25/93 | 4/14 | 14/50 | No | Log Reg/ | TP, SR, CV |
| | | | | | k-SVM | |
| T3 | 54/324 | 4/14 | 14/50 | No | Log Reg | TP, SR |
| T4 | 47/200 | 4/14 | 14/50 | No | Log Reg | TP, SR |
| T5 | 25/114 | 4/14 | 14/50 | No | Log Reg | TP, SR |
| T6 | 25/114 | 4/14 | 17/41 | No | Log Reg | TP, SR, CV |

### Predictions & Tuning

As discussed above, the datasets (e.g., training, validating, testing, etc.) may be pre-processed using, for example and without imputing limitation, simple moving average (SMA) smoothing to remove noise from the raw data. Each channel of the training dataset can be smoothed out with, for example and without imputing limitation, a window of 10 seconds and the testing dataset can be smoothed out with a window of 30, 45, 60, 90, 100, 110, 120, 180, and 600 seconds. Furthermore, a rate of change of the main features, such as, in the case of TP, SR, and CV, first (TP′, SR′, CV′) and second (TP″, SR″, CV″) order derivatives can be added to the datasets and/or included as features. SR change (e.g., the first order derivative or SR′) may be filtered to convert values between zero and 0.3 to zero and as a result smooth changes in slurry rate data.

In one example, L1 regularization, also called least absolute shrinkage and selection operator (LASSO) regression, can be combined with the logistic regression model, in order to shrink less important features towards zero, and a small C value (or regression constant) for stronger regularization. Table 2 below summarizes a set of trials reflecting the combination of L1 regularization and logistic regression models. Initial results (e.g., an initial list with start and end time flags) can be filtered to remove start and end time predictions that are too close to each other to be considered a stage (e.g., by applying a minimum threshold distance or the like) and, as a result, a finalized prediction may be produced obtained.

TABLE 2
Trial results generated from a combination of logistic regression and L1
regularization models.

| | Training | Validation | Test | | | |
|---|---|---|---|---|---|---|
| | (Wells/ | (Wells/ | (Wells/ | | | |
| Trial | Stages) | Stages) | Stages) | SMA | Model | Features |
| T7 | 25/114 | 4/14 | 17/41 | No | Log Reg, L1 | TP, SR, CV, |
| | | | | | regularization | TP′, SR′, |
| | | | | | | CV′, TP″, |
| | | | | | | SR″, CV″ |
| T8 | 25/114 | 4/14 | 17/41 | No | Log Reg, L1 | SR′, CV |
| | | | | | regularization | |
| T9 | 25/114 | 4/14 | 17/41 | No | Log Reg, L1 | TP, SR, CV, |
| | | | | | regularization | TP′, SR′, |
| | | | | | | CV′, TP″, |
| | | | | | | SR″, CV″ |
| T10 | 25/114 | 4/14 | 17/41 | No | Log Reg, L1 | TP, SR, CV, |
| | | | | | regularization | SR′, CV′, |
| | | | | | | SR″, CV″ |
| T11 | 25/114 | 4/14 | 17/41 | 45, 60, | Log Reg, L1 | TP, SR, CV, |
| | | | | 90, 100, | regularization | SR′, CV′, |
| | | | | 110, | | SR″, CV″ |
| | | | | 120, | | |
| | | | | 180 and | | |
| | | | | 600 | | |
| | | | | seconds | | |
| T12 | 25/114 | 4/14 | 17/41 | 30 | Log Reg, L1 | TP, SR, CV, |
| | | | | seconds | regularization | SR′, CV′, |
| | | | | | | SR″, CV″ |

As a result of the above, a model including a logistic regression and an L1 regularization can be generated and trained (e.g., according to method 200). Accuracy, precision, and recall of the trained model can be calculated and the logistic regression classifier can be combined with the final features to achieve accurate results and faster running times. In some examples, flag predictions by a combined model have an accuracy of approximately 90 percent.

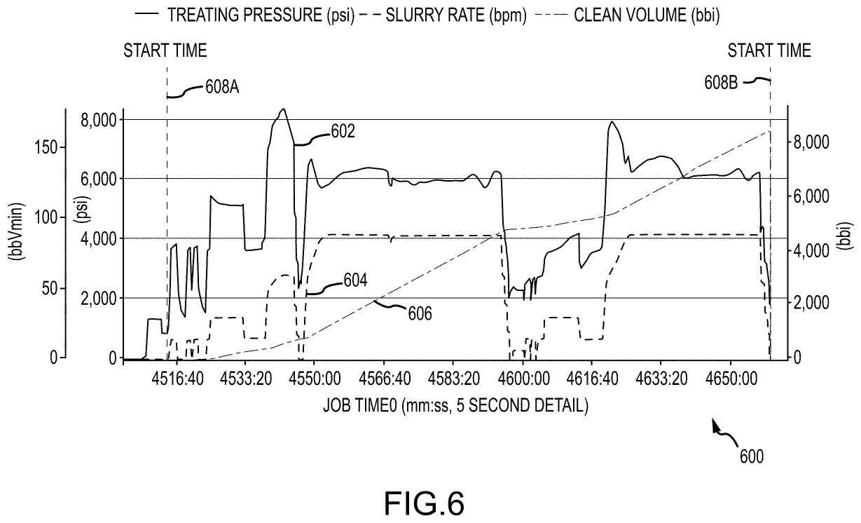

FIG. 6 depicts an example of hydraulic fracturing stage start time and stage end time predictions generated by a trained machine learning model such as discussed above. In particular, the trained machine learning model identifies an accurate start time, labeled as start time flag 608A, and an accurate end time, labeled as end time flag 608B, disregarding noise and trivial changes of rate and pressure which may be observed at the beginning of the respective file. The trained machine learning model processes features from TP 602, SR 604, and CV 606 pre-processed plot lines.

Using the above techniques and methods, various flags can be predicted by one or more trained machine learning models. For example, instantaneous shut-in pressure (ISIP) flags and associated pressure values, and other drilling, fracturing, and completion operation events and values can be identified from well data to aid in planning well operations, etc. The remainder of the disclosure discusses various examples of these other flags and associated values.

### ISIP Flag Prediction

In one example, the disclosed systems and methods can enable determination and prediction of various critical values used in drilling and completion operations (e.g., hydraulic fracturing practices), such as instantaneous shut-in pressure (ISIP). ISIP is commonly used to determine, among other measures, minimum principal stress in a downhole environment. Minimum principal stress can, in turn, be used to determine treatment, fracturing, and other various stage pressure values. ISIP is generally defined as a final injection pressure value minus a pressure drop due to friction within the wellbore and/or perforations of a slotted liner.

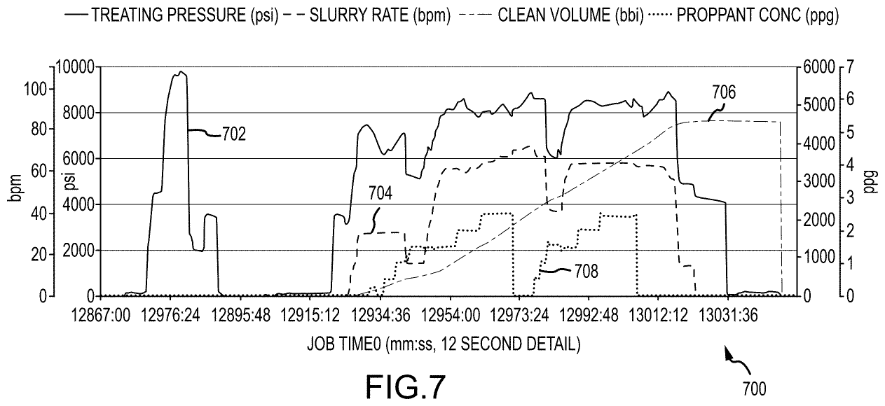

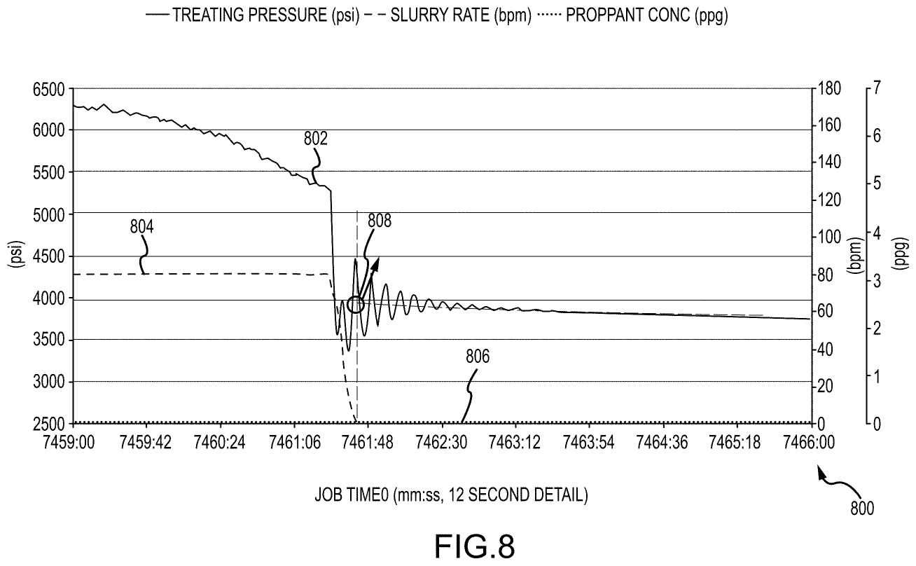

FIG. 7 depicts a plot 700 of a set of data channels TP 702, SR 704, CV 706, and PC 708 which may be used by a machine learning model trained to determine ISIP values to produce predictions (e.g., flags) of pressure values correlated to an ISIP event. FIG. 8 depicts a plot 800 including an ISIP flag 808 identified by a trained machine learning model and based on values for TP 802, SR 804, and PC 806.

In order to determine ISIP values, preprocessing, model training, refining, selection, and model application may be performed in sequence, as discussed above. In some examples, method 200 discussed above is performed to train multiple machine learning models including a neural network and a trained classifier (e.g., a logistic regression model, a LASSO regularization model, or a combination of the two as discussed above) to generate ISIP event flags. In particular, once a start time and an end time have been chosen (e.g., a start and end time index list has been extracted), further processing can generate a predicted ISIP. The further processing may include filtering out data from the start index, selecting a sample time segment such as 45 seconds of treating pressure data, outlier removal, further data clipping, regression, and then ISIP value prediction.

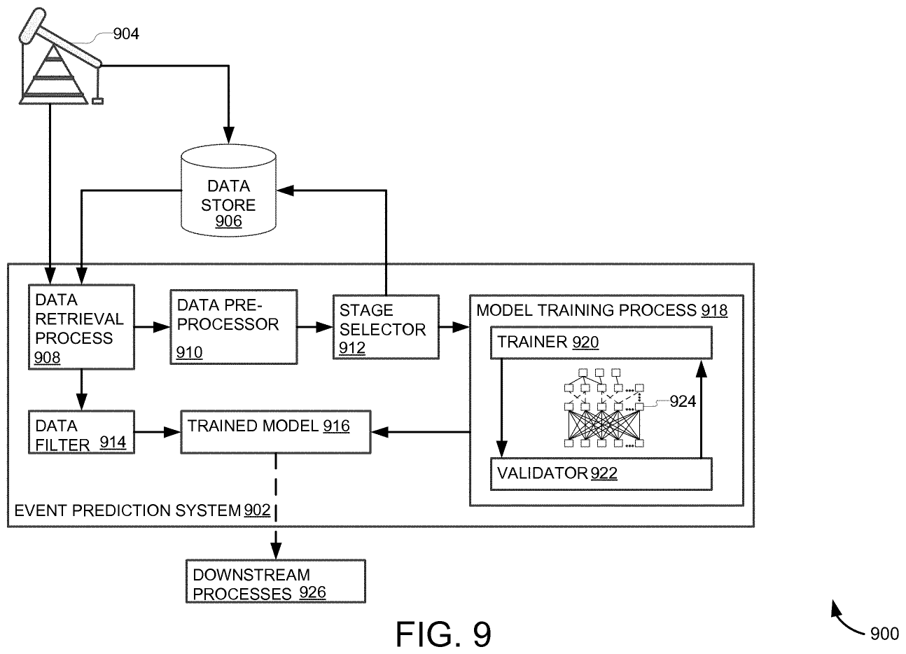

FIG. 9 depicts a system environment 900 which may be used to generate event flags, such as the ISIP flags discussed above. Additionally, system 900 may perform method 200, in whole or in part, to generate various event flags, such as start times, end times, etc. System environment 900 may be implemented as an onsite or remote server architecture. In some examples, system environment 900 may be distributed across a cloud hosted service or services, or the like.

System 900 includes an event prediction system 902 which is communicably coupled to a data store 906 and/or a well site 904. In some examples, data store 906 and/or well site 904 may be co-located to event prediction system 902. In some examples, data store 906 and/or well site 904 may be accessed by event prediction system 902 over a network such as a local area network (LAN), virtual private network (VPN), wide area network (WAN), the Internet, etc.

Event prediction system 902 may receive well data from well site 904 or data store 906. Generally, data store 906 stores historical data from, for example, well site 904 and the stored historical data may be used to train a machine learning model according to the systems and methods disclosed herein. Nevertheless, data retrieval process 908 may provide the received well data to a data pre-processor 910 and/or a data filter 914. Where the received data is directly from a well environment, data filter 914 receives the data for generating new event flags with a trained machine learning model. In comparison, where the received data is from data store 906, data pre-processor 910 may receive the data to be prepared and used in training a machine learning model.

Data pre-processor 910 applies transformations to the data and may perform various other processes on the data in order to clean, prune, smooth, standardize, scale, etc. the data for improved use in training the machine learning model. For example, data pre-processor 910 may perform appropriate operations by method 200 discussed above to generate pre-processed data for a stage selector 912.

Stage selector 912 determines stages (e.g., portions of the pre-processed data) with which to train a machine learning model. For example, where event prediction system 902 uses a trained machine learning model to identify start and stop times of stages, the respective stages may be identified by stage selector 912 and associated pre-processed data may be provided to downstream processes. Likewise, where a machine learning model is trained to identify ISIP, or other events, stage selector 912 may identify particular stage data for training the machine learning model where identifying said events includes consideration of well stages.

Nevertheless, the pre-processed data is portioned according to stage selector 912 and then provided to a model training process 918. Here, model training process 918 is depicted as training a neural network 924, but it will be understood that model training process 918 may train various machine learning models such as logistic regressions, Markov models, Bayesian networks, etc.

Model training process 918 includes a trainer 920 and a validator 922 which may iteratively train, validate, and, if necessary, retrain or further train neural network 924 as discussed above. In particular, trainer 920 may use a designated and appropriately pre-processed portion of the data to update model weights (e.g., via back propagation, equilibrium propagation, etc.) based on error values against labels of the training data. Validator 922 performs a check of neural network 924 using a designated and appropriately pre-processed portion of the data to validate training progress of neural network 924 (e.g., by determining accuracy, etc. of the trained model) using labels of the validating data.

Machine learning based subsystems can include both supervised and unsupervised learning (e.g., for working with labeled and unlabeled data respectively, etc.). Models trained via supervised machine learning can perform regression and classification processes (e.g., classifiers) and unsupervised machine learning models may perform clustering and association processes. Further, supervised and unsupervised machine learning models may be combined or utilized jointly to seamlessly perform, for example, automated pre-processing (e.g., feature engineering) and classification.

Start times, end times, and veracity (e.g., true/false determination of a data value) may be among classifications provided by neural network 924 (e.g., where neural network 924 is a classifier). Generally, neural network 924 is first initialized to random weights and then forward propagation (e.g., propagation of values from feature input into an input layer to classification output from an output layer) is used to generate predictions. The generated predictions are compared to training data trainer 920 to determine an error, which is used to back propagate a weight update to each node within neural network 924 (e.g., within each hidden layer, etc.). The resultant model (e.g., after training to a threshold error value) can provide classifications and/or regression values as outputs.

As a result, model training process 918 generates a trained model 916. In some cases, trained model 916 may actually include multiple trained models operating in a coordinated manner. In one example, where trained model 916 identifies and flags ISIP values, trained model 916 includes a logistic regression model and a neural network, which may be trained by model training process 918 sequentially, in tandem, iteratively, or some combination thereof. Nevertheless, trained model 916 receives data from data filter 914. Based on the filtered data, trained model 916 may generate event flag predictions (e.g., stage start/stop times, ISIP values, etc.), which may be provided to downstream processes 924. In some examples, downstream processes 924 may include a graphical user interface (GUI) or the like for direct user access and review of the predictions. In some examples, downstream processes 924 include automated or third party systems accessed directly or via application programming interface (API) to, for example and without imputing limitation, determine drill controls, generate other predictions, trigger alerts, etc.

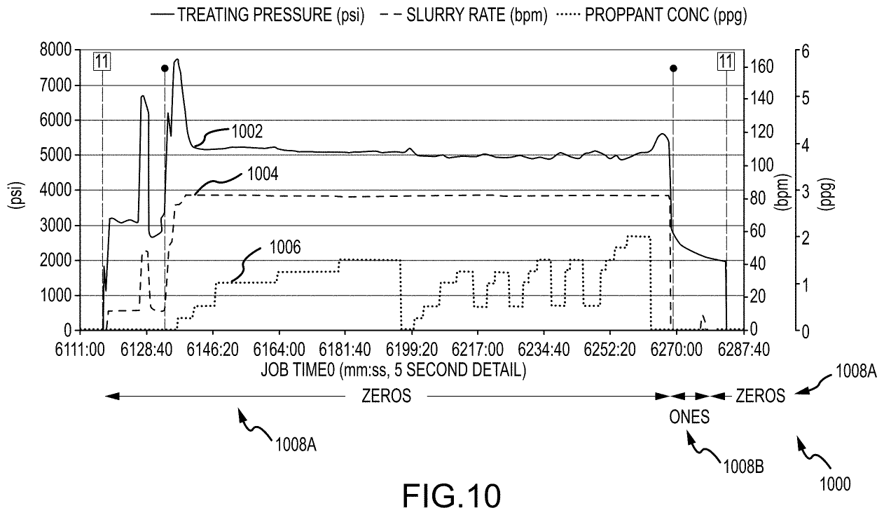

As discussed above, training data used by event prediction system 902 may be pre-labeled. FIG. 10 depicts a plot 1000 of pre-labeled training data for training a model to predict ISIP values. The labels include binary values (e.g., “0” or “1”) associated with regions 1008A and 1008B, respectively, of plot 1000 correlated to an ISIP value. As with other plots, plot 1000 includes data for TP 1002, SR 1004, and PC 1006. While three particular data channels are depicted here, it is understood that other data channels may be used with, or instead of, each of TP 1002, SR 1004, and PC 1006 without departing from the scope and spirit of the disclosure. Additionally, training data can be collected from a multitude of stages and labeled.

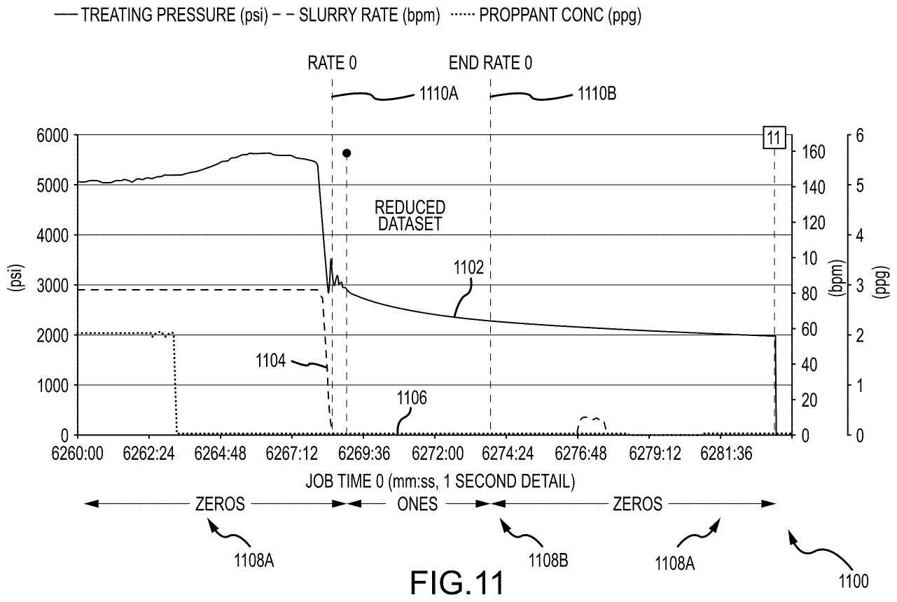

FIG. 11 depicts a plot 1100 of labeled data collected from multiple stages. Each stage is labeled to include a first flag 1110A (e.g., “Rate 0”) positioned at an end of a job when a slurry rate (SR) is equal or close to “0” and a respective treating pressure (TP) value begins to decrease. A second flag 1110B (e.g., “End Rate 0”) is positioned some amount of time after first flag 1110A and before the treating pressure changes a constant behavior into a sharp decline towards “0”. In effect, data channels for TP 1102, SR 1104, and PC 1106, are used for performing supervised training of a model (e.g., by model training process 918 discussed above).

In one example, where training data is configured in a “.csv” or other row-based format, a column containing a value of “0” or “1” is included (e.g., appended to the data via concatenation, join, etc.) in order to represent whether a respective data point (e.g., row) is within a “Rate 0” to “End Rate 0” interval. In particular, the row-based format allows for concatenating training data into a single file (e.g., a single training set) via concatenation and the like.

A validation training set can be constructed similarly to the training data set described above (e.g., concatenated using the same features, etc.). The same tagging process may be performed on the validation data set and both the training and validation dataset features can be standardized by removing a respective mean and scaling to unit variance (e.g., operation 214 discussed above).

A test dataset can be constructed from data having the same features as the training and validation data sets described above. A simple moving average (SMA) can be applied to filter the test dataset (e.g., for smoothing purposes, etc.). A neural network model trained to identify an area needed to determine an ISIP flag may generate labels that identify the “Rate 0” through “End Rate 0” area of each stage in the test data. In one example, the neural network model may have an input layer, three two-node hidden layers, and a single output layer where a prediction threshold may be select for values greater than 0.001.

For example, and without imputing limitation, rectified linear unit (ReLU) and/or sigmoid activation functions may be used in the nodes within the neural network. In addition, an Adam optimizer can be used to improve back propagation. In some cases, the neural network has been trained with hyper-parameters including 10 epochs and batch sizes of 32, though it is understood that various hyper-parameters may be used without departing from the scope and spirit of the disclosure. Once trained, the neural network recognizes data intervals that can be used in predicting ISIP (e.g., by a downstream model, etc.).

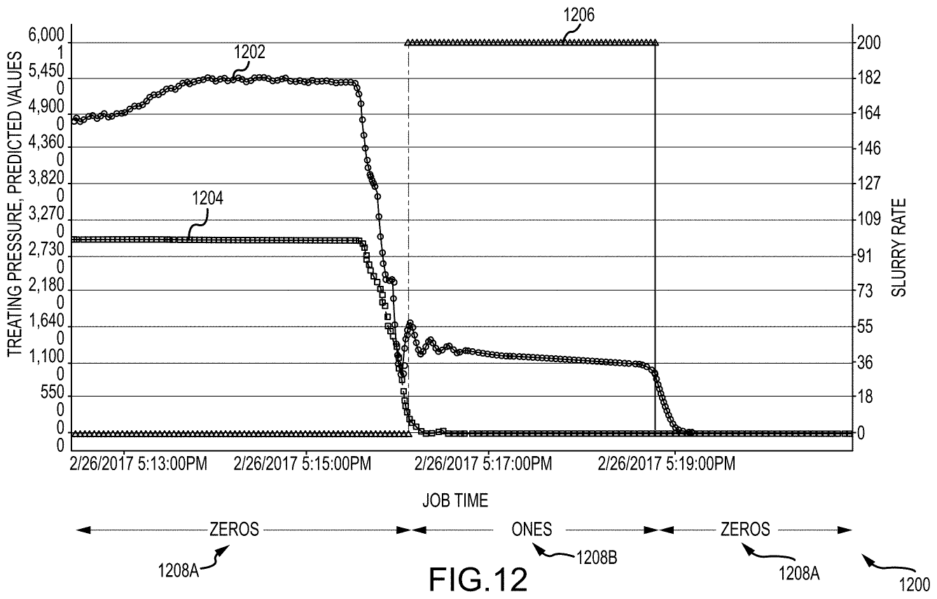

FIG. 12 depicts a plot 1200 including a data interval classification 1206 output by a neural network as discussed above. In particular, the neural network has identified an accurate interval for further processing to predict an ISIP flag. One indication of the accuracy of data interval classification 1206 is a strong correlation to zeros and ones Boolean flags 1208A, 1208B respectively, as seen in plot 1200. Here, the neural network identifies data interval 1206 based on features of data for TP 1202 and SR 1204, though it is understood that other embodiments may identify a data interval for ISIP detection using other data channels and related features.

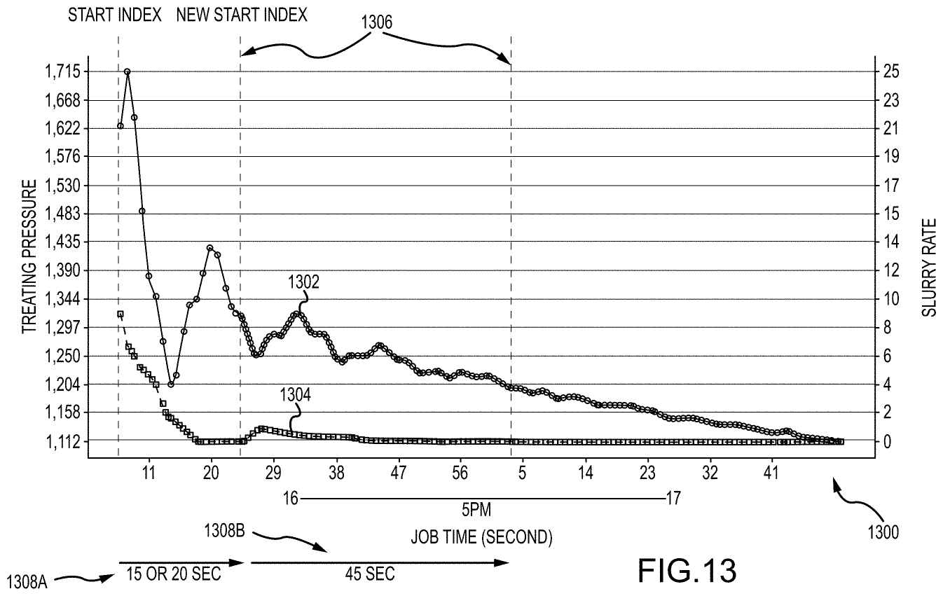

FIG. 13 depicts a plot 1300 of labeled data (e.g., produced by the neural network discussed in FIG. 12 above) that has been smoothed (e.g., according to operation 214 discussed above). In particular, a filter extracts a portion 1306 of data classified with a “1” by the neural network above.

In on example, TP 1302 and SR 1304 are smoothed by a simple moving average (SMA) and a start index 1301 is selected by filtering the first 10 to 20 seconds of data following an initial “Rate 0” label as discussed above. The first 40 to 50 seconds of smoothed data following the start index can then be provided as a new dataset to downstream processes (e.g., a logistic regression model, etc.) for generating ISIP flags.

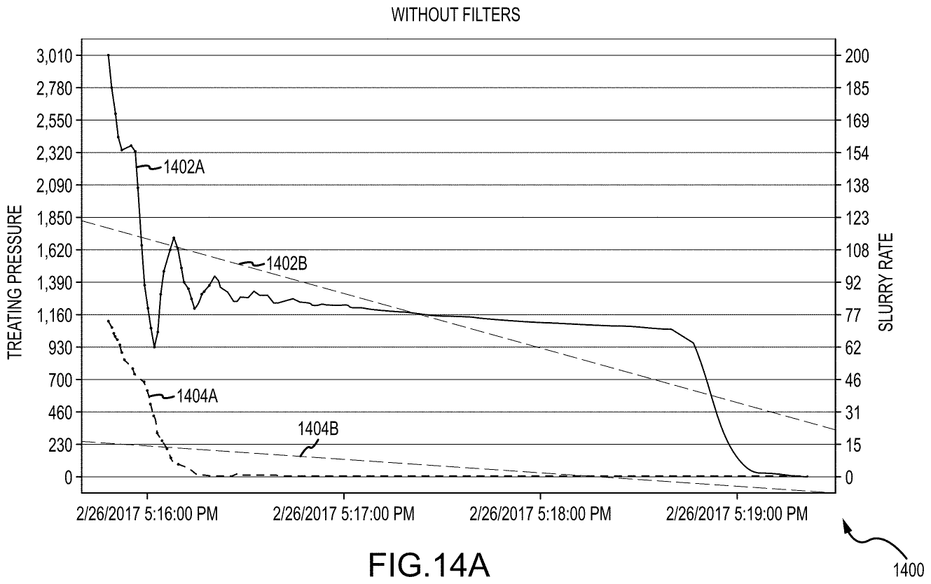

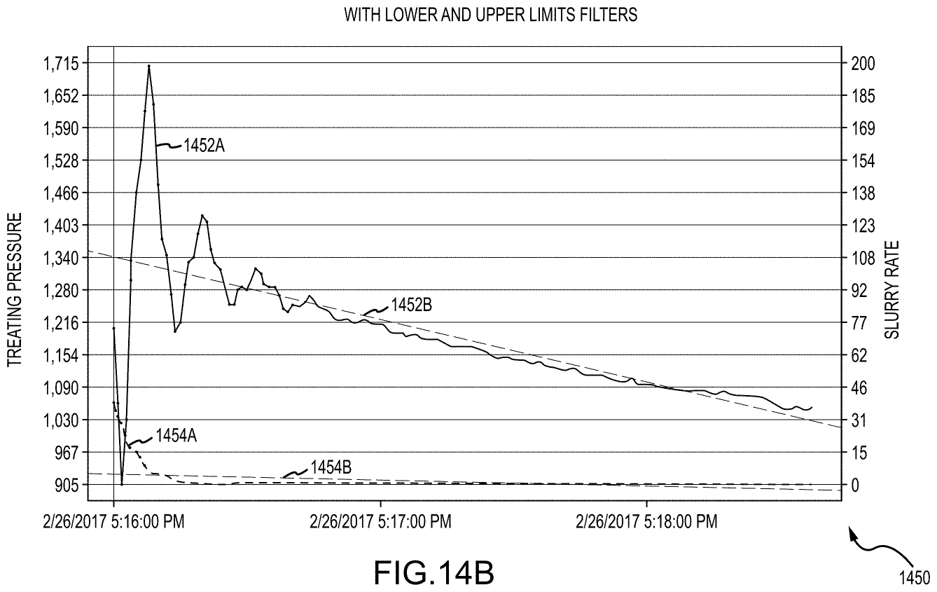

In some examples, outliers can be removed from the new dataset to further prepare the data for ISIP flagging. FIGS. 14A-B respectively depict a plot 1400 of a dataset with outliers left in data for TR 1402A and SR 1404B and a plot 1450 of the same dataset with outliers filtered out from TR 1452A and SR 1452B, according to lower and upper limit filters according to equations (1) and (2). In particular, when limit filters of equations (1) and (2) are applied, outlying data points are removed (e.g., data outside of a modified standard deviation is removed) and a smoother and more constricted dataset is generated.

lower limit=mean−X*standard deviation (1)

upper limit=mean+X*standard deviation (2)

The improved dataset can increase efficiency and accuracy of regressions as it is more tightly bound to the mean (e.g., average) values of the data. For example, regression line 1452B more closely adheres to true data values of TP 1452A than does regression line 1402B to true data values of TP 1402A. Likewise, regression line 1454B more closely adheres to true data values of SR 1454A than does regression line 1404B to true data values of SR 1404A.

The pre-processed dataset may then be processed by a second machine learning model (e.g., a linear regression model) to predict ISIP values. In some examples, an additional time (e.g., two seconds) may be removed from the beginning or end of the considered dataset to create a more focused dataset for the linear regression model. The removal of the additional time can be effective to further reduce noise contamination of the data and/or to further focus the linear regression for more efficient prediction of the ISIP value (e.g., less data to process).

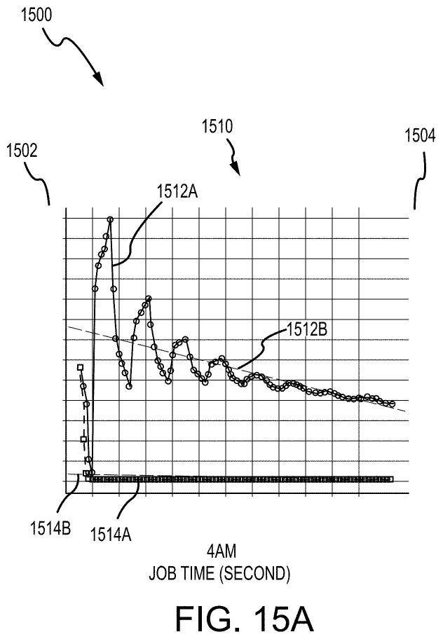

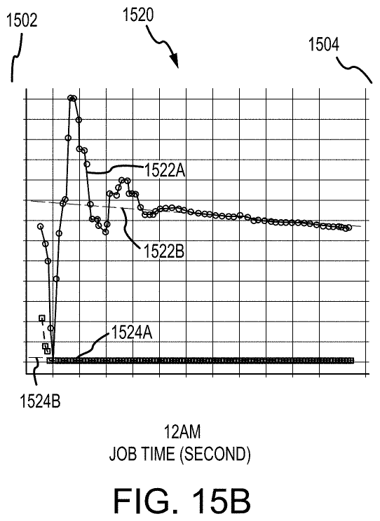

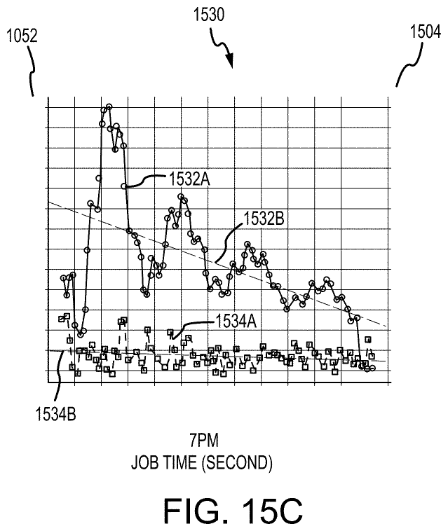

FIGS. 15A-C depict three plots 1510, 1520, 1530 of linear regressions 1512B, 1522B, 1532B for respective TPs 1512A, 1522A, 1532A and linear regressions 1514B, 1524B, 1534B for respective SRs 1514A, 1524A, 1534A. In particular, the ISIP values may be identified as pressure values 1502 of linear regressions 1512B, 1522B, 1532B at a point along time axis 1501 at which a respective SR 1514A, 1524A, 1534A is equal to “0” and intersects linear regression 1514B, 1524B, 1534B respectively.

The resulting ISIP values may be used for a variety of further downstream purposes, such as rendering a GUI through which a user may explore predictions and data or to a decision making model or algorithm such as an Al controller or the like. Additionally, using the methods and processes above, ISIP values can be predicted for multiple well stages.

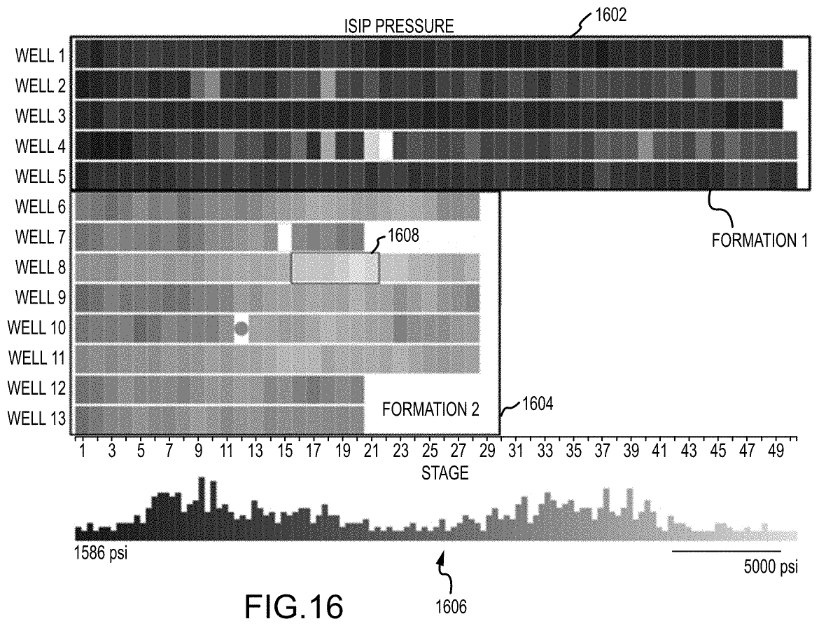

FIG. 16 depicts an ISIP value heat map 1600 which may be generated based on the resulting ISIP values for multiple well stages. In effect, the ISIP values can be used to provide visualizations and interfaces for quickly determining well characteristics (e.g., pressure build ups, stresses, rock type barriers, etc.) based on the visualizations. In some cases, multiple wells can be viewed at a glance.

Heat map 1600 includes color coded wells distributed across a first formation 1602 and a second formation 1604. Using a legend 1606, a user may review heat map 1600 to quickly identify well characteristics based on generated ISIP values for each well. Here, anomalous ISIP values 1608 indicate, for example, that a different zone within a respective formation may have been entered by a respective stage. As a result, efficient drilling and/or fracturing plans can be produced using the more comprehensive view of the well environment provided by the ISIP flags, etc.

In comparison, pressure values (and associated ISIP values) are often visualized as an undifferentiated line graph or scatter plot. In effect, it can be difficult to distinguish between and/or identify values of the undifferentiated line graph. Particularly, where pressure data exhibits substantially similar characteristics, the undifferentiated line graph may result in lines overlapping and/or in close proximity to each other. However, heat map 1600 clearly distinguishes between wells while also providing a clear indication of ISIP value by stage. In some examples, the wells may be aligned by stage start and grouped based on similar patterns in ISIP values (e.g., stage coloration, etc.). For example, the wells of first formation 1602 display substantially similar progressions of ISIP values across respective stages. As a result, it can be determined that the wells of first formation 1602 belong to a shared formation. Likewise, the wells of second formation 1604 display substantially similar progressions of ISIP values across respective stages and so, as a result, it can be determined that the wells of second formation 1604 belong to a likewise shared formation different than that of first formation 1602. In effect, petroleum engineers, for example and without imputing limitation, are able to easily and quickly discern important information about wells and respective well groupings based on heat map 1600 that may otherwise require substantial time and energy to detect by analyzing an undifferentiated line graph or the like.

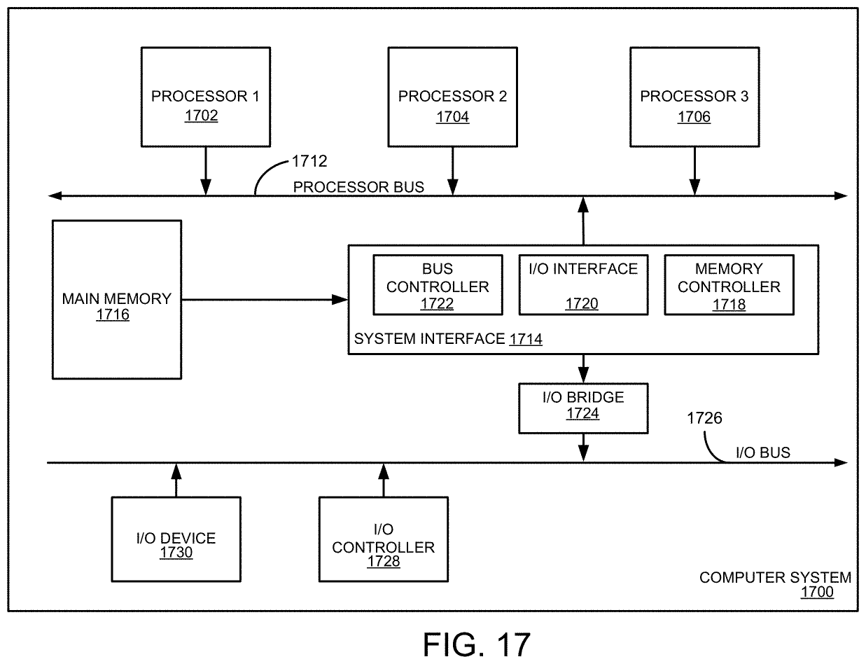

FIG. 17 is an example computing system 1700 that may implement various systems and methods discussed herein. The computer system 1700 includes one or more computing components in communication via a bus 1702. In one implementation, the computing system 1700 includes one or more processors 1704. The processor 1704 can include one or more internal levels of cache 1706 and a bus controller or bus interface unit to direct interaction with the bus 1702. The processor 1704 may specifically implement the various methods discussed herein. Main memory 1708 may include one or more memory cards and a control circuit (not depicted), or other forms of removable memory, and may store various software applications including computer executable instructions, that when run on the processor 1704, implement the methods and systems set out herein. Other forms of memory, such as a storage device 1710 and a mass storage device 1718, may also be included and accessible, by the processor (or processors) 1704 via the bus 1702. The storage device 1710 and mass storage device 1718 can each contain any or all of the methods and systems discussed herein.

The computer system 1700 can further include a communications interface 1712 by way of which the computer system 1700 can connect to networks and receive data useful in executing the methods and system set out herein as well as transmitting information to other devices. The computer system 1700 can also include an input device 1720 by which information is input. Input device 1716 can be a scanner, keyboard, and/or other input devices as will be apparent to a person of ordinary skill in the art. An output device 1714 can be a monitor, speaker, and/or other output devices as will be apparent to a person of ordinary skill in the art.

The system set forth in FIG. 17 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of operations in the methods disclosed are instances of example approaches. Based upon design preferences, it is understood that the specific order or hierarchy of operations in the methods can be rearranged while remaining within the disclosed subject matter. The accompanying method claims present elements of the various operations in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions. Data stores and data structures may be implemented as relational databases, non-relational databases, object oriented databases, and other data storage architectures and may use tables, objects, columns, pointers, and the like in implementing, for example, nodes, edges, references, etc.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for identifying characteristics of well data, the method comprising:
pre-processing well data, the well data comprising one or more data channels corresponding to one or more sensor values from a well;
smoothing the pre-processed well data with a first smoothing window; and
feeding the smoothed well data to the trained model, the trained model identifying characteristics of the received well data;
wherein the trained model has been trained by:
pre-processing a training data set of well fracturing data;
selecting multiple stages for training a model, each stage correlating to an interval in which well fracturing operations are performed, the model corresponding to the trained model;
labeling the pre-processed data based on the selected multiple stages;
smoothing the pre-processed training data with a second smoothing window, the second smoothing window of a particular size different than a size of the first smoothing window; and
training the model using the smoothed training data, the model trained to identify well data characteristics in data.

2. The method of claim 1, wherein the model comprises one or more of a logistic regression model or a neural network binary classifier.

3. The method of claim 1, wherein the characteristics include at least one of a stage start time and a stage end time, each identified by the trained model identifying a sequential portion of the received well data as from a hydraulic fracturing stage, the stage start time corresponding to a beginning time of the sequential portion and the stage end time corresponding to an ending time of the sequential portion.

4. The method claim 1, wherein selected features of the training data are smoothed, and the trained model has been further trained by selecting features from the training data, the selected features used by the trained model to identify the well data characteristics.

5. The method of claim 1, wherein feeding the smoothed well data to the trained model comprises:
fitting a linear regression model to the pre-processed well data to generate an instantaneous shut-in pressure (ISIP) flag, the ISIP flags corresponding to a pressure value correlated to a slurry rate value equal to zero.

6. The method of claim 5, wherein pre-processing the well data further comprises:
identifying one or more intervals of the well data from which ISIP values may be generated, wherein a binary neural network classifier identifies the one or more intervals; and
labeling the well data according to the identified one or more intervals.

7. The method of claim 5, further comprising generating a heat map interface based on the ISIP flags, the heat map interface comprising ISIP flags indicators for multiple stages of one or more wells, the heat map interface further comprising visual groupings of stage heat maps, the groupings corresponding to formations to which respective stage data is related, wherein the correspondence is based on the ISIP flag indicators.

8. The method of claim 1, wherein the data channels comprise one or more of a treatment pressure (TP), a slurry rate (SR), a clean volume (CV), or a proppant concentration (PC).

9. A system for identifying characteristics of well data, the system comprising:
one or more processors; and
a memory comprising instructions to:
pre-process well data, the well data comprising one or more data channels corresponding to one or more sensor values from a well;
smooth the pre-processed well data with a first smoothing window; and
feed the smoothed well data to the trained model, the trained model identifying characteristics of the received well data;
wherein the trained model has been trained by:
pre-processing a training data set of well fracturing data;
selecting multiple stages for training a model, each stage correlating to an interval in which well fracturing operations are performed, the model corresponding to the trained model;
labeling the pre-processed data based on the selected multiple stages;
smoothing the pre-processed training data with a second smoothing window, the second smoothing window of a particular size different than a size of the first smoothing window; and
training the model using the smoothed training data, the model trained to identify well data characteristics in data.

10. The system of claim 9, wherein the model comprises one or more of a logistic regression model or a neural network binary classifier.

11. The system of claim 9, wherein the characteristics include at least one of a stage start time and a stage end time, each identified by the trained model identifying a sequential portion of the received well data as from a hydraulic fracturing stage, the stage start time corresponding to a beginning time of the sequential portion and the stage end time corresponding to an ending time of the sequential portion.

12. The system claim 9, wherein selected features of the training data are smoothed, and the trained model has been further trained by selecting features from the training data, the selected features used by the trained model to identify the well data characteristics.

13. The system of claim 9, wherein feeding the smoothed well data to the trained model comprises:
fitting a linear regression model to the pre-processed well data to generate an instantaneous shut-in pressure (ISIP) flag, the ISIP flags corresponding to a pressure value correlated to a slurry rate value equal to zero.

14. The system of claim 13, wherein pre-processing the well data further comprises:
identifying one or more intervals of the well data from which ISIP values may be generated, wherein a binary neural network classifier identifies the one or more intervals; and
labeling the well data according to the identified one or more intervals.

15. The system of claim 13, wherein the memory further comprises instructions to generate a heat map interface based on the ISIP flags, the heat map interface comprising ISIP flags indicators for multiple stages of one or more wells, the heat map interface further comprising visual groupings of stage heat maps, the groupings corresponding to formations to which respective stage data is related, wherein the correspondence is based on the ISIP flag indicators.

16. The system of claim 9, wherein the data channels comprise one or more of a treatment pressure (TP), a slurry rate (SR), a clean volume (CV), or a proppant concentration (PC).

17. A non-transitory computer readable medium storing instructions that, when executed by one or more processors, cause the one or more processors to:
pre-process well data, the well data comprising one or more data channels corresponding to one or more sensor values from a well, the one or more data channels comprising one or more of a treatment pressure (TP), a slurry rate (SR), a clean volume (CV), or a proppant concentration (PC);
smooth the pre-processed well data with a first smoothing window; and
feed the smoothed well data to the trained model, the trained model identifying characteristics of the received well data;
wherein the trained model comprises one or more of a logistic regression model or a neural network binary classifier, and the trained model has been trained by:
pre-processing a training data set of well fracturing data;
selecting multiple stages for training a model, each stage correlating to an interval in which well fracturing operations are performed, the model corresponding to the trained model;
labeling the pre-processed data based on the selected multiple stages;
smoothing the pre-processed training data with a second smoothing window, the second smoothing window of a particular size different than a size of the first smoothing window; and
training the model using the smoothed training data, the model trained to identify well data characteristics in data.

18. The non-transitory computer readable medium of claim 17, wherein the characteristics includes at least one of a stage start time and a stage end time, each identified by the trained model identifying a sequential portion of the received well data as from a hydraulic fracturing stage, the stage start time corresponding to a beginning time of the sequential portion and the stage end time corresponding to an ending time of the sequential portion.

19. The non-transitory computer readable medium of claim 17, wherein feeding the smoothed well data to the trained model comprises:
fitting a linear regression model to the pre-processed well data to generate instantaneous shut-in pressure (ISIP) flags, the ISIP flags corresponding to a pressure value correlated to a slurry rate value equal to zero; and
wherein pre-processing the well data further comprises:
identifying one or more intervals of the well data from which ISIP values may be generated, wherein a binary neural network classifier identifies the one or more intervals; and
labeling the well data according to the identified one or more intervals.

20. The non-transitory computer readable medium of claim 19, wherein the instructions further cause the one or more processors to generate a heat map interface based on the ISIP flags, the heat map interface comprising ISIP flags indicators for multiple stages of one or more wells and visual groupings of stage heat maps, the groupings corresponding to formations to which respective stage data is related, wherein the correspondence is based on the ISIP flag indicators.
